(19) United States
(12) Patent Application Publication
(10) Pub. No.: US 2012/0139454 A1
(43) Pub. Date: Jun. 7, 2012

(54) DEVICE AND METHOD FOR ACTUATING AND DIAGNOSING STEPPER MOTORS

(75) Inventors: Thomas Roessler, Hitzhofen (DE); Werner Wolfrum, Hamburg (DE)

(73) Assignee: CONTI TEMIC MICROELECTRONIC GMBH, NUERNBERG (DE)

(21) Appl. No.: 13/389,685

(22) PCT Filed: Aug. 10, 2010
(86) PCT No.: PCT/EP2010/061615

§ 371 Date: Feb. 9, 2012

(30) Foreign Application Priority Data
Aug. 19, 2009 (DE) 10 2009 038 111.2

(51) Int. Cl. H02P 8/40; H02P 8/34

(52) U.S. Cl. 318/5; 318/696

(57) ABSTRACT

A device for actuating and diagnosing at least two stepper motors, wherein each of the stepper motors has at least two windings, each of the first windings of the stepper motors and the second windings of the stepper motors are connected in series by a first line and a second line respectively. At least one diagnosis unit is provided, by which electrical parameters and/or changes in the values thereof are measured in the first and/or second line, and the at least one diagnosis unit is implemented such that the function of the stepper motors is analyzed using the measured parameters and/or the changes in value thereof.

The present invention relates to a device and a method for actuating and diagnosing at least two stepper motors.

In order to synchronously operate headlights, valves or ventilation flaps in a vehicle using a plurality of stepper motors, devices or methods with the aid of which a plurality of stepper motors can be actuated in synchronism are required. Furthermore, it is necessary to regularly measure physical characteristic variables of the stepper motors so that malfunctioning can be identified in good time.

Electromagnetic stepper motors are special synchronous motors. Just like these, stepper motors also comprise a stationary stator and a rotating rotor/moving rotor. They usually have salient poles in the stator, the windings of said poles being cyclically supplied with power. This produces a virtually discontinuously rotating magnetic field which is followed by the rotor in a stepwise manner. The rotary movement is therefore produced by deliberately switching on and switching off individual windings. The direction of rotation and rotation speed of the motor can be controlled in an extremely simple manner in this way.

The prior art discloses various methods and devices for actuating a plurality of stepper motors.

Laid-open specification DE 44 17 369 A1 discloses a device for operating stepper motors, wherein a plurality of stepper motors are connected in parallel to a common supply voltage such that they can be individually switched on/off and are actuated by a common controller. In particular, FIG. 3 shows an arrangement for actuating a plurality of stepper motors, wherein these stepper motors are bipolar stepper motors and both the direction of current flow of each motor winding can be individually changed and the supply of current to each motor winding can be individually interrupted by switching the switch which is associated with each individual motor winding. A diagnosis device for measuring characteristic variables of the stepper motor is indicated but not described in any detail.

DE 295 04 735 U1 describes a device having a plurality of unipolar stepper motors which can each be fed individually by a supply voltage. In this case, the stepper motors are connected in parallel to a common supply voltage and actuated by a common control unit. A diagnosis device is not provided.

Patent specification DE 199 51 365 C1 describes an arrangement for operating a plurality of stepper motors, the operating voltages of said stepper motors in each case being lower than the common supply voltage. In order to drive a plurality of stepper motors at a reliable operating voltage which is lower than the supply voltage of the system, the motors are divided into at least two groups. The windings (phases, coils) of all the stepper motors of one group are connected in parallel with one another and to the common supply line. The two groups of motors are connected in series. Each individual winding of a motor is switched on/off by means of a semiconductor switch which is connected in series to this winding. A diagnosis device is not provided.

In half-step operation, the step number per revolution can be doubled by current flowing through in each case both stator coils between the full steps. This results only in half the torque but twice the positional accuracy. Furthermore, the cited prior art does not provide an adequate diagnosis device which can be realized in a technically simple manner. Micro-step operation is realized by deliberately changing the current amplitudes of stator windings which are switched on at the same time. To this end, controllable current generators are used in the individual winding phases. As a result, virtually any desired stepping angle can be achieved independently of the number of winding phases of the stator.

The object of the present invention is therefore that of providing a device and a method for actuating and diagnosing a plurality of stepper motors, as a result of which the motors can be operated both in the full-step and in the half-step to micro-step modes and characteristic variables of the stepper motors can be diagnosed with a low level of technical expenditure.

According to the invention, this object is achieved by a device having the features of claim 1 and a method having the features of claim 7. Advantageous refinements of the invention are the subject matter of the dependent claims.

The device according to the invention for actuating and diagnosing at least two stepper motors comprises
at least in each case two windings for the at least two stepper motors, wherein in each case the first windings of the stepper motors are connected in series by a first line and the second windings of the stepper motors are connected in series by a second line,
at least one diagnosis unit, electrical characteristic variables and/or changes in the value of said electrical characteristic variables in the first and/or second line being measured by said diagnosis unit, and
the at least one diagnosis unit is formed in such a way that the functioning of the stepper motors is evaluated on the basis of the measured characteristic variables and/or the changes in the value of said measured characteristic variables.

The basic idea of the invention is to connect the windings (phases, coils) of various motors in series. In the process, the first windings of the motors are connected in series to one another and the second windings of the motors are connected in series to one another etc. Furthermore, at least one diagnosis unit is provided between the rows of windings in order to monitor the operating state of the motors.

As a result, it is possible to simultaneously monitor all the stepper motors with the aid of a single diagnosis unit which is arranged between the rows of windings. Therefore, it is possible, for example, to detect a short circuit with respect to the ground or operating voltage of a motor winding, a short circuit between the windings, a winding fracture or an overload in a motor using this single diagnosis unit.

On account of the series connection of the respective windings of the stepper motors, current can be supplied to said windings independently of the number, inductance or winding resistance. Therefore, the motors can be operated both in the full-step mode and the micro-step mode.

In one advantageous refinement of the invention, the detected electrical characteristic variables and/or changes in value are compared with previously stored set-point values. The result advantageously achieved is that the measured characteristic variables can be evaluated.

A control unit is provided in a further advantageous refinement of the invention, said control unit interchanging data with the diagnosis unit and actuating the at least two stepper motors as a function of the data in the diagnosis unit. In this case, the diagnosis unit compares the measured characteristic variables of the stepper motors with defined threshold values and, particularly when there is a deviation in the measured characteristic variables compared to the threshold values, sends a signal to the control unit, so that the control unit interrupts the supply of current to the stepper motors. This prevents damage to the stepper motors.

The diagnosis unit is expediently formed in such a way that it can be used when the stepper motor is moving or when it is stationary. When said stepper motor is stationary, the pulsed holding currents of the stepper motors are analogously read in by a microcontroller via a low-pass filter and compared with threshold values. Overall, this leads to improved monitoring reliability since diagnosis can be performed in every state.

In a further advantageous refinement of the invention, the electrical characteristic variables comprise the current, voltage and/or phase shift between the coils. Therefore, the critical electrical characteristic variables of a stepper motor are detected, it being possible to evaluate the state using said electrical characteristic variables.

In a further advantageous refinement of the invention, at least two moving parts are each moved by one of the at least two stepper motors. These moving parts are, for example, two headlights, two ventilation flaps or two valves of a motor vehicle. As a result of the fact that the stepper motors move in synchronism, it is possible for the headlights, ventilation flaps or valves to move in synchronism.

The use of identical stepper motors also results, in contrast to parallel actuation, in the advantage of a lower power requirement and therefore also lower power loss since the current in the series circuit is the same across all components of a circuit.

A further advantage is that all the motors which are connected in accordance with the invention no longer continue to be supplied with current in the event of a fault, for example in the event of one of the motors breaking or in the event of a loss of a common feed line, since the electrical circuit is opened. As a result, the motors are better protected and the service life of the motors is extended.

Further details and advantages of the invention are explained with reference to the appended figures, in which:

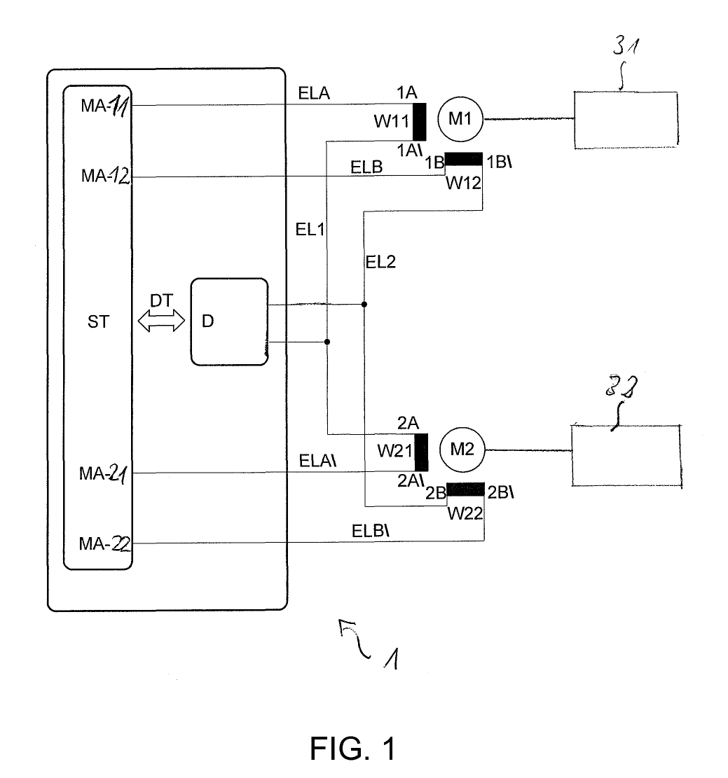

FIG. 1 schematically shows stepper motors with a diagnosis device; and

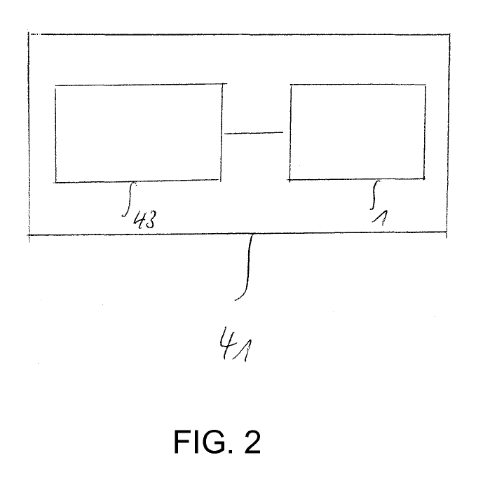

FIG. 2 schematically shows a motor vehicle.

In the following description of a preferred embodiment of the present invention, identical reference symbols denote identical or comparable components.

FIG. 1 shows the device 1 according to the invention. The device 1 comprises a control unit ST, a diagnosis device D and two stepper motors M1, M2. The two stepper motors M1 each have two windings W11, W12 (M1) and W21, W22 (M2). The two stepper motors M1, M2 are actuated in synchronism by means of the control unit ST. The control unit ST has four connections MA-11, MA-21, MA-12, MA-22. The connection MA-11 is electrically connected to the motor connection 1A of the first winding W11 of the first motor M1 by means of an electrical line ELA. The connection MA-21 of the control unit ST is electrically connected to the motor connection 2A\ of the first winding W21 of the second stepper motor M2 by means of a further electrical line ELA\. The windings W11 and W21 of the two stepper motors M1 and M2 are connected in series by means of an electrical line EL1. In this case, the line EL1 connects the motor connection 1A\ of the winding W11 of the first motor M1 to the motor connection 2A of the winding W21 of the second motor M2.

Accordingly, the connection MA-12 of the control unit ST is electrically connected to the motor connection 1B of the second winding W12 of the first motor M1 by means of an electrical line ELB. The connection MA-22 of the control unit ST is electrically connected to the motor connection 2B\ of the second winding W22 of the second stepper motor M2 by means of a further electrical line ELB\. The windings W12 and W22 of the two stepper motors M1 and M2 are connected in series by means of an electrical line EL2. In this case, the line EL2 connects the motor connection 1B\ of the winding W12 of the first motor M1 to the motor connection 2B of the winding W22 of the second motor M2.

The diagnosis unit D is connected to the two lines EL1 and EL2. Data interchange DT takes place between this diagnosis unit D and the control unit ST. This diagnosis unit D monitors, for example, the voltage or the voltage fluctuation on the two lines EL1 and EL2. In the event of a predetermined threshold value being exceeded or undershot, for example due to a short circuit with respect to the electrical ground or supply voltage, this diagnosis unit D then sends a signal to the control unit ST. The control unit ST then interrupts, for example, the supply of current to the stepper motors M1 and M2.

Stepper motors with six or eight connections can analogously be actuated and diagnosed in a manner connected in series. Further diagnosis units for further rows of windings can be provided in this case.

The device according to the invention or this method according to the invention can be used, for example, to operate mechanically moveable parts, such as two headlights for headlight beam adjustment, valves or ventilation flaps of a vehicle 41. In this case, two identical headlights are actuated by two stepper motors which are connected in series.

In the vehicle 41, each stepper motor M1, M2 for a headlight is connected to the mechanical system of the headlights by means of a lever. As a result, both headlights of the vehicle are moved at the same time. Non-uniform movement of the motors M1, M2 would lead to non-uniform movement of the headlights and therefore to a different lighting angle of the headlights.

The invention can advantageously be operated when the motors M1, M2 are moving or when the motors M1, M2 are stationary. When said motors are stationary, the pulsed holding currents of the stepper motors M1, M2 are analogously read in by a microcontroller via a low-pass filter and compared with threshold values. In a stepper motor, the holding current is the current which holds the respective stator in the current position. As a result of the holding current being considerably lower, approximately 50 mA, than the operating current, approximately 500 mA, there is a relatively large mark-to-space ratio, that is to say a relatively low frequency, with the energy integrated with respect to time remaining the same. Accordingly,

only signals with the relatively low frequencies which are present when the motors are stationary are measured by a low-pass filter. This different measurement when the motor M1, M2 is moving or when the motor M1, M2 is stationary is also described as asynchronous sampling.

FIG. 2 shows a motor vehicle 41 which comprises the device 1 and an indicator device 43.

Data interchange DT takes place between the diagnosis unit D and the control unit ST. This diagnosis unit D monitors, for example, the voltage or the fluctuation in voltage on the two lines EL1 and EL2. In the event of a predetermined threshold value being exceeded or undershot, for example due to a short circuit with respect to the electrical ground or supply voltage, this diagnosis unit D then sends a signal to the control unit ST. The control unit ST then interrupts, for example, the supply of current to the stepper motors M1 and M2 and sends a signal to the indicator device 43 where this deviation is indicated.

The indicator device 43 can be arranged directly in the dashboard of the motor vehicle 41, so that a deviation in the threshold value is immediately indicated to the driver of the motor vehicle 41. However, the indicator device 43 can also be configured in such a way that the transmitted signals are not indicated until said device is in a workshop.

1-14. (canceled)

15. A device for actuating and diagnosing at least two stepper motors, wherein:
the at least two stepper motors each include a first winding and a second winding, wherein the first windings of the stepper motors are connected in series by way of a first line and the second windings of the stepper motors are connected in series by way of a second line;
the device for actuating and diagnosing the stepper motors comprising:
at least one diagnosis unit connected to the first line and the second line and configured for measuring electrical characteristic variables and/or changes in a value of the electrical characteristic variables in the first line and/or in the second line; and
wherein said at least one diagnosis unit is configured to evaluate a functionality of the at least two stepper motors on a basis of the measured characteristic variables and/or of the changes in the value of the measured characteristic variables.

16. The device according to claim 15, wherein said diagnosis unit is configured to compare the detected electrical characteristic variables and/or changes in value with previously stored set-point values.

17. The device according to claim 15, which further comprises a control unit connected to interchange data with said diagnosis unit and to actuate the at least two stepper motors as a function of the data in said diagnosis unit.

18. The device according to claim 15, wherein said diagnosis unit is configured to be used when the stepper motor is moving or when the stepper motor is stationary.

19. The device according to claim 15, wherein said diagnosis unit is configured to continuously measure the electrical characteristic variables and/or changes in value.

20. The device according to claim 15, wherein the electrical characteristic variables are selected from the group consisting of a current, a voltage, and a phase shift between the coils of the stepper motors.

21. The device according to claim 15, wherein the at least two stepper motors are configured to move at least two mechanically moveable parts.

22. The device according to claim 21, wherein the two mechanically moveable parts are components selected from the group consisting of two headlights, two valve flaps, and two ventilation flaps.

23. A motor vehicle, comprising the device according to claim 15 and an indicator device connected thereto.

24. A method of actuating and diagnosing at least two stepper motors, the stepper motors each having at least a first winding and a second winding, and wherein the first windings of the at least two stepper motors are connected in series by way of a first line and the second windings of the at least two stepper motors are connected in series by way of a second line, the method which comprises:
measuring with at least one diagnosis unit electrical characteristic variables and/or changes in a value of the electrical characteristic variables in one or both of the first line and the second line; and
evaluating with the at least one diagnosis unit a functionality of the stepper motors on a basis of the measured characteristic variables and/or the changes in the value of the measured characteristic variables.

25. The method according to claim 24, wherein the evaluating step comprises comparing, with the diagnosis unit, the electrical characteristic variables and/or the changes in the value of the electrical characteristics variables with previously stored set-point values.

26. The method according to claim 24, which comprises exchanging data between the diagnosis unit and a control unit, and actuating the at least two stepper motors with the control unit as a function of the data in the diagnosis unit.

27. The method according to claim 24, wherein the at least two stepper motors are connected to move at least two mechanical parts.

28. The method according to claim 24, wherein the at least two stepper motors are connected to move at least two headlights, two valve flaps, or two ventilation flaps.
